(19) United States
(12) Patent Application Publication
(10) Pub. No.: US 2022/0033101 A1
(43) Pub. Date: Feb. 3, 2022

(54) Lightweight Bracket for Storm Hardening of Aircraft Components

(71) Applicant: LOON LLC, Mountain View, CA (US)

(72) Inventors: Thomas Swanson, Mountain View, CA (US); Matthew Joshua Yee, Sunnyvale, CA (US); John Cromie, Menlo Park, CA (US)

(73) Assignee: LOON LLC, Mountain View, CA (US)

(21) Appl. No.: 16/942,536

(22) Filed: Jul. 29, 2020

(51) Int. Cl. B64D 45/02; H02G 13/00; B64B 1/58

(52) U.S. Cl. CPC B64D 45/02; B64B 1/58; H02G 13/80

(57) ABSTRACT

The technology relates to techniques for lightweight brackets for storm hardening of aircraft components. A bracket flange for protecting an electronics assembly from electrical storm activity can include a leg element coupled to and extending from a component of a vehicle and a first bar element extending from another end of the leg element on a plane substantially parallel to the component and over a part of an electronics assembly. The location of the bracket flange can be determined using a lightning attachment survey configured to indicate a part of the electronics assembly to which a lightning streamer attaches during an electrical surge. The location and size of the bracket flange may be configured to divert surge current away from the part of the electronics assembly to which the lightning streamer attaches in the lightning attachment survey.

### BACKGROUND OF INVENTION

Electronic components of aircraft such as airplanes are typically protected from lightning strikes and other electrical damage caused by electrical storm activity by locating the electrical components within the metallic skin of the aircraft. As such, when the aircraft experiences a direct lightning strike, large currents (e.g., hundreds of thousands of amps in some cases) flow through the electrically conductive skin of the aircraft and then back out to the atmosphere (before reaching ground) and the electronics within the skin are not exposed to the induced currents.

In some cases, electronics assemblies (e.g., antennae, exterior lights, and sensors) of aircraft are located externally to the skin and are coupled to the internal electronics of the aircraft by wiring. The wiring can also couple currents induced by electrical storm activity into the sensitive interior electronics of the aircraft, causing damage. In some cases, this issue is solved by using optical cables (which do not conduct current) rather than electrical wires to couple the external electronics assemblies to the electronics assemblies inside the skin of the aircraft. In other cases, shielded wires (i.e., wires containing one or more insulated conductors enclosed by a common conductive layer within the wire themselves) are used to isolate the currents caused by electrical storm activity to the external skin of the aircraft, thereby protecting the sensitive internal electronics from current coupling from the external electronics to the sensitive internal electronics of the aircraft.

Lighter than air (LTA) aerial vehicles (e.g., balloon vehicles) are being considered for a variety of purposes, including providing data and network connectivity, data gathering (e.g., image capture, weather and other environmental data, telemetry), surveillance, and systems testing, among others. Balloon vehicles can utilize a balloon envelope or a non-rigid hull filled with a gas mixture that is lighter than air to provide lift. Balloon vehicles typically do not contain a metallic skin (or an airframe, or a fuselage), and therefore the electronics of such vehicles can be exposed to the environment.

### BRIEF SUMMARY

The present disclosure provides techniques for lightweight brackets for storm hardening of aircraft components. A bracket flange for protecting an electronics assembly from electrical storm activity can include a leg element coupled to and extending from a base plate at one end of the leg element, an the electronics assembly being mounted, at least in part, to the base plate; and a first bar element extending from another end of the leg element on a plane substantially parallel to the base plate and over a part of the electronics assembly, wherein the leg element is coupled to a location on an outer perimeter of the base plate, the location being determined using a lightning attachment survey configured to indicate a part of the electronics assembly to which a lightning streamer attaches during an electrical surge, the electrical surge configured to mimic the electrical storm activity; wherein the location is configured to place the leg element and first bar element in a configuration configured to divert surge current away from the part of the electronics assembly to which the lightning streamer attaches in the lightning attachment survey, and wherein the leg element and first bar element are formed of a conductive material. In an example, the leg element comprises two or more legs, each of the two or more legs coupled to a different location on the outer perimeter of the base plate. In another example, the leg element and the first bar element form a cage over the electronics assembly. In another example, the bracket flange also includes a second bar element extending from an end or an edge of the first bar element in a plane substantially perpendicular to the first bar element. In another example, the leg element and first bar element comprise strips of metal. In another example, the electronics assembly comprises a component of an aerial vehicle. In another example, a squib configured to terminate the flight of the aerial vehicle is coupled to the base plate and the location is configured to place the leg element and the first bar element in a configuration configured to divert surge current away from the squib and prevent the squib from firing prematurely. In another example, the base plate further comprises an inlet port for filling a lighter than air envelope with a gas, and the bracket flange is configured to provide a space without legs or bars blocking the inlet port. In another example, the bracket flange further comprises a lightning rod.

A method for providing a bracket flange to protect an electronics assembly on a vehicle from electrical storm activity can include performing a lightning attachment survey configured to indicate a part of an electronics assembly to which a lightning streamer attaches during an electrical surge, the electrical surge configured to mimic the electrical storm activity; determining, based on the lightning attachment survey, a placement of a bracket flange comprising a leg element and a first bar element; determining a size of the bracket flange; forming the bracket flange from a lightweight conductive material; and coupling the bracket flange to a component of a vehicle according to the placement, wherein the electronics assembly is electrically insulated from the bracket flange. In an example, the placement of a bracket flange is based on the location part of the electronics assembly to which the lightning streamer attaches during the lightning attachment survey. In another example, the leg element comprises two or more legs, each of the two or more legs coupled to a different location on the component of the vehicle. In another example, the leg element and the first bar element form a cage over the electronics assembly. In another example, the bracket flange further comprises a second bar element extending from an end or an edge of the first bar element in a plane substantially perpendicular to the first bar element. In another example, the leg element and first bar element comprise strips of metal with thicknesses from 1 mm to 5 mm. In another example, the component of the vehicle and the electronics assembly are components of an aerial vehicle. In another example, a squib configured to terminate the flight of the aerial vehicle is coupled to the component of the vehicle and the placement is configured to place the leg element and the first bar element in a configuration configured to divert surge current away from the squib and prevent the squib from firing prematurely. In another example, the component of the vehicle further comprises an inlet port for filling a lighter than air envelope with a gas, and the bracket flange is configured to provide a space without bars blocking the inlet port. In another example, the component of the vehicle is a base plate of an aerial vehicle. In another example, the leg element is coupled to an outer perimeter of the base plate and the electronics assembly is coupled to the base plate. In another example, the component of the vehicle is a down connect coupling an envelope or a hull to a payload of the vehicle, the electronics assembly comprises wiring, and the wiring is coupled to the down connect. In another example, the size of the bracket flange comprises a width and a height sufficient to divert surge current from the electrical surge away from the electronics assembly. In another example, the bracket flange further comprises a lightning rod.

### BRIEF DESCRIPTION OF THE DRAWINGS

FIGS. 1A-1C show simplified schematics of an example portion of an aircraft, with a base plate and an exposed electronics assembly, in accordance with some embodiments.

FIGS. 2A-2C show simplified schematics of another example portion of an aircraft, with a base plate and exposed electronics assembly, in accordance with some embodiments.

FIGS. 3A-3C show simplified schematics of an example portion of a balloon vehicle, with a base plate and two exposed electronics assemblies, in accordance with some embodiments.

FIGS. 4A-4C show examples of lightning attachment surveys with different bracket flanges, in accordance with some embodiments.

FIG. 5A shows a simplified schematic in projection view of an example bracket flange 500 for a balloon vehicle, in accordance with some embodiments.

FIG. 5B shows a simplified schematic in projection view of an example portion of a balloon vehicle, with a bracket flange mounted to a base plate and extending over an electronics assembly, in accordance with some embodiments.

FIG. 6A shows a simplified schematic in projection view of an example portion of a balloon vehicle with a down connect, in accordance with some embodiments.

FIG. 6B shows a bracket flange coupled to a part of a down connect and extending over an electronics assembly, in accordance with some embodiments.

FIG. 7 is a flowchart for a method for providing a bracket flange to protect an electronics assembly on a vehicle from electrical storm activity, in accordance with some embodiments.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The invention is directed to a bracket flange design for storm hardening of an aircraft component, particularly one with electronics exposed to an external environment of the aircraft. Electronics assemblies that are exposed to electrical surges from electrical storm activity, are distinguished from, for example, electronics assemblies that are encased within a metal skin (or within an airframe, or fuselage) of an aircraft. Lightning or other electrical storm events (collectively “electrical storm activity”) can damage exposed electronics when an aircraft flies above, below, or near, an electrical storm. In some cases, exposed electronics of an aircraft (e.g., a superpressure balloon) are protected from electrical storm activity using an electrically conductive, lightweight and discontinuous enclosure. In some cases, the enclosure is a bracket flange (i.e., a bracket) including one or more legs that support one or more bars positioned over the exposed electronics, where the legs and bars are made from an electrically conductive material. In some cases, the legs and bars form a cage that wholly or partially covers the electronics assembly. In other cases, the exposed electronics can be protected from electrical storm activity using an electrically conductive covering with a plurality of holes in the covering to reduce the weight of the covering and to allow for gases to flow through the covering.

The bracket flanges and methods described herein protect exposed electronics assemblies of aerial vehicles (e.g., balloon vehicles) from damage due to electrical storm activity, which can directly or indirectly damage the external electronics. For example, a lightning strike or lightning streamer of an electrical storm can directly couple to the exposed electronics, or an electrical storm can indirectly induce damage to electronics of an aircraft that is in the proximity of an inter-cloud lightning storm by causing rapid changes to the electrical fields surrounding the electronics of the aircraft.

In some examples, a balloon vehicle (e.g., superpressure, dirigible, or other type) may include an exposed electronics assembly at an apex of a balloon envelope or hull comprising electronics associated with one or more sensors, a termination trigger, a power system, a communications unit, among other vehicle components. Said balloon vehicle also may have exposed wires along a support structure (e.g., a tendon) extending from the apex to a base structure (e.g., an altitude control system (ACS)), as well as exposed wires along a down connect from the envelope or hull to a payload. When such a balloon vehicle flies above, below, or near, a lightning or other electrical storm event (collectively “electrical storm activity”), the vehicle may experience large voltages (e.g., 10s to 100s of kV) across the vehicle, and thus large currents (e.g., 100s to 1000s of amps) can flow through the conductive elements of the vehicle. This can cause damage to circuit boards and wires, inadvertently fire squibs (e.g., thereby triggering tendon cutters utilized in a flight termination event), and otherwise wreak havoc on elements of the electronics assemblies.

These exposed electronics elements may be protected from such damaging electrical activity by an enclosure composed of metal or other conductive material. However, it is often advantageous to not fully enclose, and in fact to minimize the amount of enclosure of, an electronics assembly for a variety of reasons, such as to reduce the total mass of the vehicle, provide ventilation, and/or allow access to parts of the electronics assembly and adjacent elements (e.g., openings for the passage of tubes, air, gas, and/or liquids). Rather than completely enclosing an electronics assembly (e.g., within a fuselage of an aircraft), a bracket may be provided to divert unwanted electrical currents (i.e., surge currents) away from the electronics assembly, the bracket adding minimal enclosure of the electronics assembly and minimal mass to the vehicle compared to enclosures that fully encase the electronics assembly (or compared to enclosures that fully encase the electronics assembly with the exception of small ventilation holes).

A method for designing a lightweight bracket to divert surge current includes performing a lightning attachment survey (e.g., in compliance with test methodology and procedures described in Radio Technical Commission for Aeronautics (RTCA) DO-160 Section 22 and/or Section 23) to test which parts of an electronics assembly form lightning streamers. A lightning attachment survey may comprises hanging a component of the aerial vehicle (e.g., a base plate or a structure coupling an envelope or hull to a payload) upon which the electronics assembly is mounted in an open space, and coupling the component to a generator configured to apply an electrical surge to the component to mimic the conditions an aircraft may experience due to electrical storm activity. The component of the aerial vehicle (e.g., a base plate or down connect) can be made from metal (e.g., aluminum), plastic, or other material with sufficient mechanical properties to support the assemblies that are mounted to the component. Based on the formation of lightning streamers observed on the electronics assembly from the lightning attachment survey, placement of leg and bar elements of a bracket flange on the component may be determined. The bracket flange may comprise at least one leg coupled to the component (e.g., a base plate) and one bar extending from the leg over at least part of the electronics assembly. The electronics assembly may be mounted on insulating standoffs on the base plate. In some embodiments, the electronics assembly may be mounted on the bracket flange (e.g., using electrically insulating standoffs that electrically isolate the electronics assembly from the bracket flange). In either case, the electronics assembly is configured to conduct surge currents away from the electronics assembly. In other words, the bracket leg and bar can be placed such that lightning streamers attach to the bracket flange and the surge current from a lightning transient is conducted through the bracket instead of the electronics assembly. In some cases, the electronics assembly can itself be insulated (e.g., contain electronics components enclosed within an insulating package, or contain a wire with an insulating sheath) and a portion of the electronics assembly can be in physical contact with the bracket flange while being electrically insulated from the bracket flange. In some cases, the electronics assembly is coupled to a component of an aerial vehicle (e.g., a base plate) and is electrically insulated from the bracket flange because the electronics assembly and the bracket flange are not physically touching (i.e., the insulation is provided by an air gap).

In some examples, a leg of the bracket flange may be in a substantially perpendicular plane to the base plate and a bar of the bracket flange may be in a substantially parallel plane to the base plate. In some examples, the bar may extend to another bar and/or leg coupled to another location (e.g., on the outer perimeter of the base plate). In an example, part or all of the bracket flange may comprise a plurality of legs supporting a plurality of bars to form a cage. The legs and bars of the cage may be molded or formed as a single piece or may comprise coupled segments (e.g., two or more pieces mechanically attached). Legs and bars may be placed to avoid openings in the base for conduits (e.g., gas fill inlets or gas exit locations). In some examples, bracket flange legs may be coupled to a load ring (e.g., where the load ring is an outer perimeter region of a base plate or other structure) using a bolt. In some cases, the load ring is electrically isolated from the electronics assembly. For example, the electronics assembly can be coupled to the base plate or bracket flange using electrically insulating standoffs, or the electronics assembly can be coupled to a region of the base plate that is electrically isolated from the load ring. In some examples, a serrated lock washer may be placed in between the leg and the structure to which the leg is coupled (e.g., a load ring), which may cut through both materials when clamped by the bolt to contact both materials (i.e., ensure contact between both materials). In some cases, the legs of the bracket flange are coupled to other locations of a component of a vehicle, such as the interior of a base plate, the surface of a down connect, or to any location on a vehicle component (e.g., in the vicinity of an exposed electronics assembly) to which lightning streamers are prone to attach.

In some cases, a size of the bracket flange is determined such that the bracket flange effectively diverts surge current from the electrical surge away from the electronics assembly. In some cases, the height and/or width of the bracket flange is determined such that the bracket flange effectively diverts surge current from the electrical surge away from the electronics assembly. For example, the bracket flange and the electronics assembly can both be mounted to a base plate and the bracket flange can be designed to be tall enough that there is adequate distance between the electronics assembly and the bracket flange. For example, if an electronics assembly to be protected has a height H, then a bracket flange (optionally fitted with lightning rods) can partially or wholly cover the electronics assembly such that there is at least a distance H separating the electronics assembly from the bracket flange at the closest point between the electronics assembly and the bracket flange. In some embodiments, a bracket flange partially or wholly covers an electronics assembly such that the electronics assembly is sufficiently shaded by the bracket flange. For example, the electronics assembly can be shaded if it is located within a volume created by a set of cones extending down from a portion of the bracket flange towards the electronics assembly. The cones can each have an approximately 45-degree angle at the apex of the cones, and can extend from all points on the bars of the bracket flange (e.g., from all portions of the bracket flange that are in planes substantially parallel to the plane of a base plate to which the bracket flange is attached). In other embodiments, the electronics assembly would be protected if it is located within a volume created by cones with different apex angles (e.g., approximately 60-degrees, or approximately 30-degrees, or less than 30-degrees).

In some examples, such a bracket may be comprised of a lightweight conductive material, such as thin metal (e.g., with thickness from 0.1 mm to 10 mm, from 1 mm to 10 mm, or from 1 mm to 5 mm), plastic with metal coating, or bonding straps. In some examples, lightning rods also may be coupled to the component of the aerial vehicle (e.g., a base plate) or bracket flange, extending out from the component of the aerial vehicle (e.g., the base plate) or bracket flange in a substantially perpendicular plane to the component of the aerial vehicle (e.g., the base plate).

In some cases, an electronics assembly that extends outward from the center of a component (e.g., a base plate) to form an outcropping is particularly susceptible to lightning streamers attaching to the electronics assembly. In such cases, a bracket flange may be used that extends beyond the outer perimeter of the component to partially or wholly cover the electronics assembly such that lightning streamers attach to the bracket flange and surge currents are conducted away from the electronics assembly. Such a bracket flange can thereby protect the electronics assembly. In some cases, the electronics assembly is coupled to an outer perimeter of a component (e.g., to a load ring of a base plate), the bracket flange is also coupled to the outer perimeter of the component, and the electronics assembly is electrically insulated from the component and from the bracket flange (e.g., using insulating standoffs between the electronics assembly and the component).

In some cases, exposed electronics coupled to a base plate at the apex of a balloon vehicle are particularly susceptible to lightning streamers attaching to the electronics assembly. In such cases, a lightweight bracket flange with many openings for gas to escape (e.g., in the event of a flight termination initiated by cutting the envelope proximal to the base plate) can be used to protect the electronics assembly. In such cases, the bracket flange can be made from lightweight electrically conductive materials (e.g., thin strips of metal, metal meshes, and/or plastic coated in metal) to minimally effect the weight of the balloon. For example, the bracket flange can be made from sheet metal with a thickness from 0.1 mm to 10 mm, or from 1 mm to 10 mm, or from 1 mm to 5 mm, or from 2 mm to 3 mm, or about 2 mm, or about 2.5 mm. The bracket flange can also be designed such that the legs and bars provide access to a gas inlet, whereby the balloon envelope can be filled (e.g., with hydrogen or helium).

In some cases, a flight termination system contains an exposed electronic assembly configured to fire squibs that is coupled to a base plate at the apex of a balloon vehicle. For example, the squibs can terminate a flight by releasing a cutting arm (or by directly cutting tendons supporting the envelope) causing the envelope to be cut or rupture and to release the lift gas of the balloon vehicle. Such flight termination systems can be particularly susceptible to lightning streamers attaching to the electronics assembly, which can result in premature firing of the squibs. In such cases, a lightweight bracket flange with many openings for gas to escape can be used to protect the electronics assembly and prevent the squibs from prematurely firing.

In some cases, more than one bracket flange may be used to protect more than one electronics assembly. For example, different electronics assemblies may be coupled to different components (e.g., to more than one base plate, or to a base plate and a structure coupling an envelope or hull to a payload) and different bracket flanges can be coupled to each component. In some cases, different electronics assemblies may be coupled to the same components (e.g., a base plate) in different locations and different bracket flanges can be coupled to the component in different locations to protect the different electronics assemblies. In some cases, one larger flange and one or more smaller flanges can be used to partially or wholly cover specific exposed electronics assemblies.

In some cases, the bracket flange partially or wholly covering exposed electronics assemblies can be formed from a single piece (e.g., a piece of sheet metal) containing a plurality of holes. The bracket flange can be sufficiently lightweight and allow for the escape of gas by using lightweight materials (e.g., a thin sheet of metal) and by incorporating enough holes.

In some cases, bracket flanges can be placed on the outside of exposed cables to protect the exposed cables from damage due to electrical storm activity. For example, an electrical assembly can be a cable or a wire (i.e., where a cable of a wire is any type of electrical connecting element, such as insulated electrical wires that transmit power or data) that electrically connects electronics coupled to an envelope or hull of an aerial vehicle (e.g., a lighter than air vehicle) and electronics coupled to a payload of the vehicle. In this example, the wiring can be coupled to a down connect component (in such a way that the wires are electrically insulated from the down connect component) and a bracket flange can be coupled to the down connect component that partially or wholly covers and protects the wiring. The bracket flange can contain legs that are coupled to the down connect component and one or more bars coupled to the legs, where the bars are located over the wiring. In some cases, exposed cables can be mounted on or inside bracket flanges shaped like cylindrical tubes.

In some cases, grounding wires or straps are coupled to a bracket flange or between two bracket flanges partially or wholly covering exposed electronics assemblies to conduct surge currents away from the electronics assemblies (e.g., into a load ring of a base plate).

Example Systems

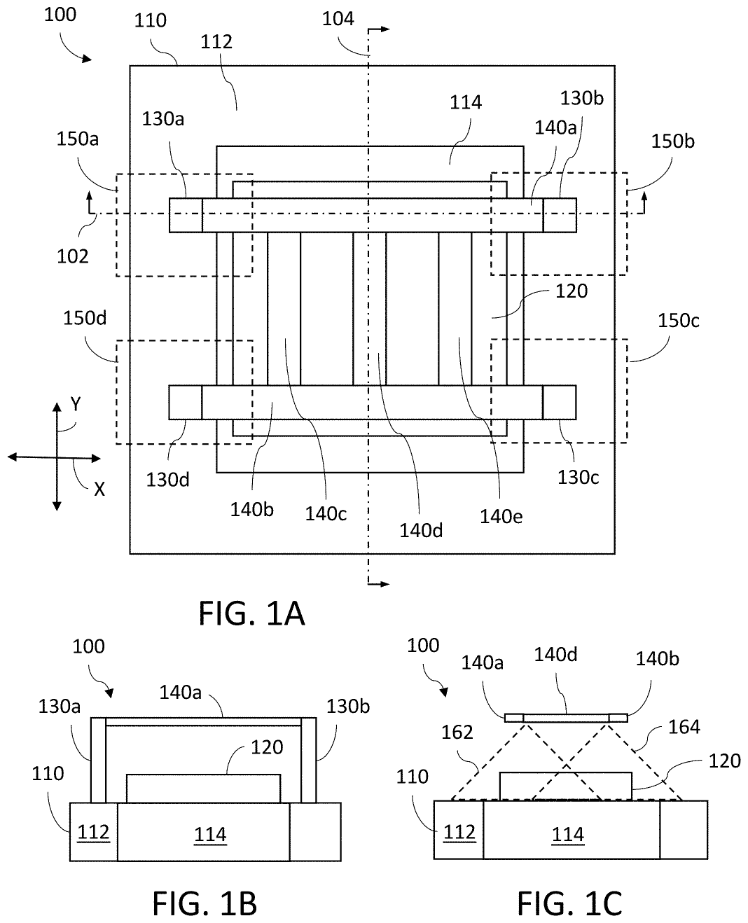

FIGS. 1A-1C show simplified schematics of an example portion of an aircraft 100, with a base plate 110 and an exposed electronics assembly 120. FIG. 1A is a plan view schematic, with two cut plane lines 102 and 104. FIGS. 1B and 1C show side view schematics of cross-sectional views corresponding to cut plane lines 102 and 104, respectively.

In this example, the upper surface of base plate 110 and the electronics assembly 120 are exposed to the environment and are exposed to electrical surges from electrical storm activity, as opposed to, for example, electronics assemblies that are encased within a metal skin (or within an airframe, or fuselage) of an aircraft. The electronics assembly 120 is protected by a lightweight enclosure with many openings through which air and gases flow. The enclosure is a bracket flange made from a conductive material (e.g., metal) in the example shown in FIGS. 1A-1C. The bracket flange contains four legs 130a-d in planes substantially perpendicular to base plate 110, each leg coupled to the base plate 110, and five bars 140a-e extending substantially parallel to the base plate 110. In this example, legs 130a-d and bars 140a-e of the bracket flange form a cage over the electronics assembly 120.

The electronics assembly 120 is electrically insulated from the bracket flange so that surge currents can be conducted away from electronics assembly 120 by the bracket flange without damaging electronics assembly 120. FIGS. 1A-1C show an example where the electronics assembly 120 is mounted to the base plate 110. The base plate 110 in this example contains an outer perimeter region 112 and an inner region 114, where the electronics assembly 120 is mounted to the inner region 114 of the base plate 110. In some cases, outer perimeter region 112 and inner region 114 are electrically insulated from each other, and as a result the electronics assembly 120 is electrically insulated from the bracket flange and from the portion 112 of the base plate 110 to which the bracket flange is coupled. In some cases, the electronics assembly 120 is mounted to the base plate using electrically insulating standoffs between the electronics assembly 120 and the base plate 110 to electrically insulate the electronics assembly 120 from the base plate 110. In such a case, the outer perimeter region 112 and the inner region 114 do not need to be electrically insulated from each other. In other embodiments, the electronics assembly 120 can be coupled to a leg (e.g., 130a-d) or bar (e.g., 140a-e) of the bracket flange in such a way that the electronics assembly 120 is electrically insulated from the bracket flange (e.g., using electrically insulating standoffs or other electrically insulating spacers between the electronics assembly 120 and the bracket flange) and from the base plate 110 (by physically separating the electronics assembly 120 from the base plate 110).

FIG. 1B shows a simplified schematic of a cross-section of the example portion of the aircraft 100, taken through cut plane line 102. One end of the leg 130a is coupled to the outer perimeter region 112 of base plate 110, and the bar 140a extends from the other end of the leg 130a on a plane substantially parallel to the base plate 110 and over part of the electronics assembly 120.

The three additional bars 140c-e in the bracket flange in FIGS. 1A-1C extend from bar 140a to bar 140b in a plane substantial perpendicular to bar element 140a and parallel to the base plate 110. FIG. 1C shows a simplified schematic of a cross-section of the example portion of the aircraft 100, taken through cut plane line 104. FIG. 1C shows the configuration of bars 140a, 140b and 140d over part of the electronics assembly 120.

The electronics assembly 120 in the example shown in FIGS. 1A-1C extends laterally beyond the cage formed by the bracket flange. In other words the electronics assembly 120 extends beyond the bars 140a-e that cover the electronics assembly 120 in a direction Y shown in FIG. 1A. FIG. 1C also shows cross-sections of two cones 162 and 164 extending down from bar 140d towards electronics assembly 120 with 45-degree apex angles. Similar cones can be drawn that extend down from all of the points on all of the bars 140a-e towards the electronics assembly 120. Since the electronics assembly 120 is located within the volume created by such a set of cones extending down from the bars 140a-e, it indicates that the electronics assembly may be protected by the bracket flange. In other embodiments, the electronics assembly may be protected if it is within a volume created by a similar set of cones with different apex angles (e.g., approximately 60-degrees, or approximately 30-degrees, or less than 30-degrees). In other cases, the electronics assembly 120 does not extend laterally beyond the cage formed by the bracket flange. In other words, in some cases the electronics assembly 120 has lateral dimensions (e.g., in the direction of X or Y shown in FIG. 1A) that are smaller than the lateral dimensions of the bars of the bracket flange.

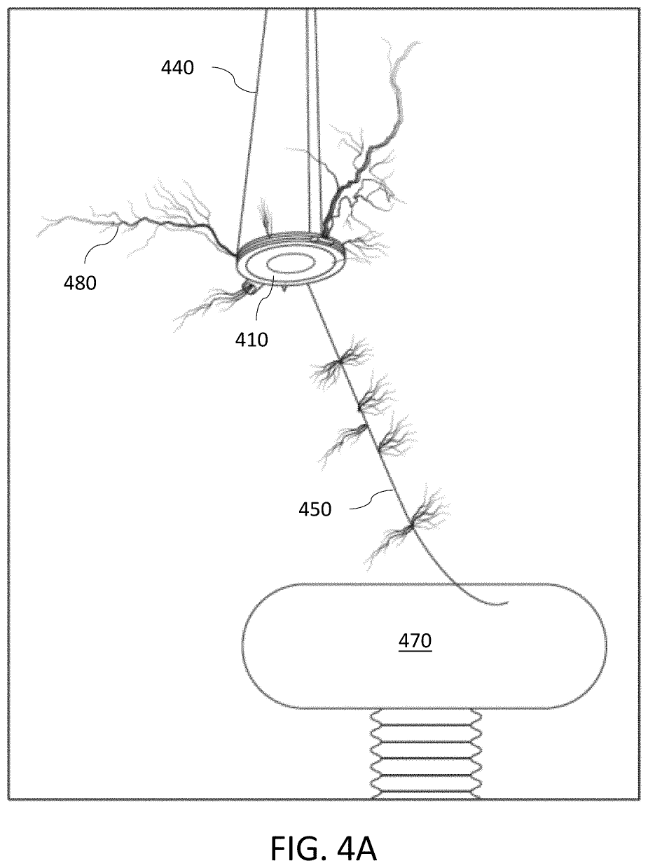

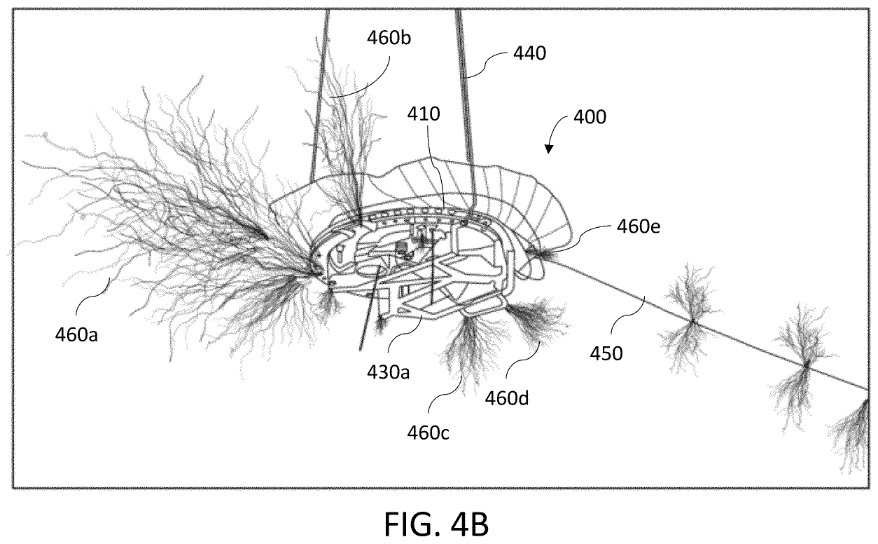

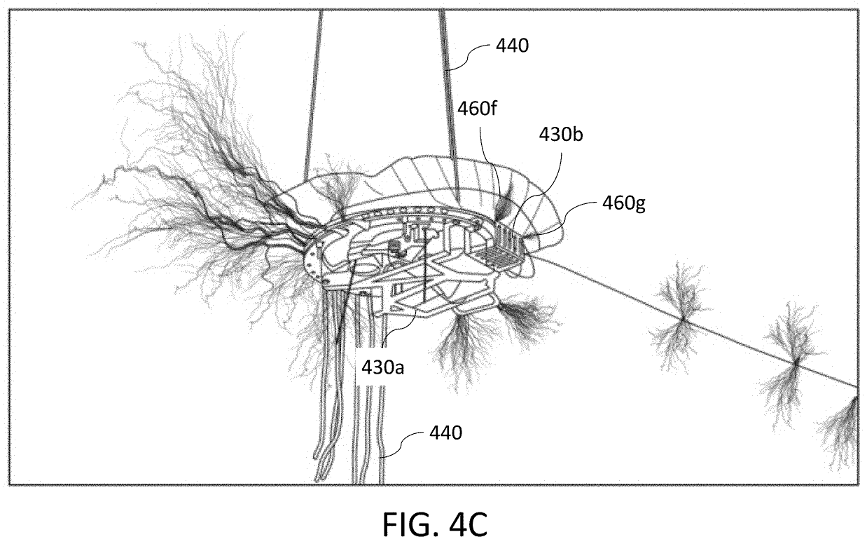

In the example shown in FIGS. 1A-1C, the legs 130a-d are coupled to the outer perimeter region 112 of the base plate 110. In some embodiments, the position of the legs 130a-d and the bars 140a-e are determined using a lightning attachment survey (see, e.g., FIGS. 4A-4C showing results of lightning attachment surveys) as described herein. In the example shown in FIG. 1A, regions 150a-d of the base plate 110 are prone to lightning attachment, as shown by lightning streamers from a lightning attachment survey (see, e.g., FIGS. 4A-4C). Legs 130a-d and bars 140a-b of the bracket flange are located within and/or partially or wholly cover regions 150a-d to prevent the lightning streamers from attaching to the electronics assembly 120. The position of legs 130a-d and bars 140a-e are further designed to direct potentials and currents away from the electronics assembly 120 thereby protecting the electronics assembly 120 from electrical storm activity.

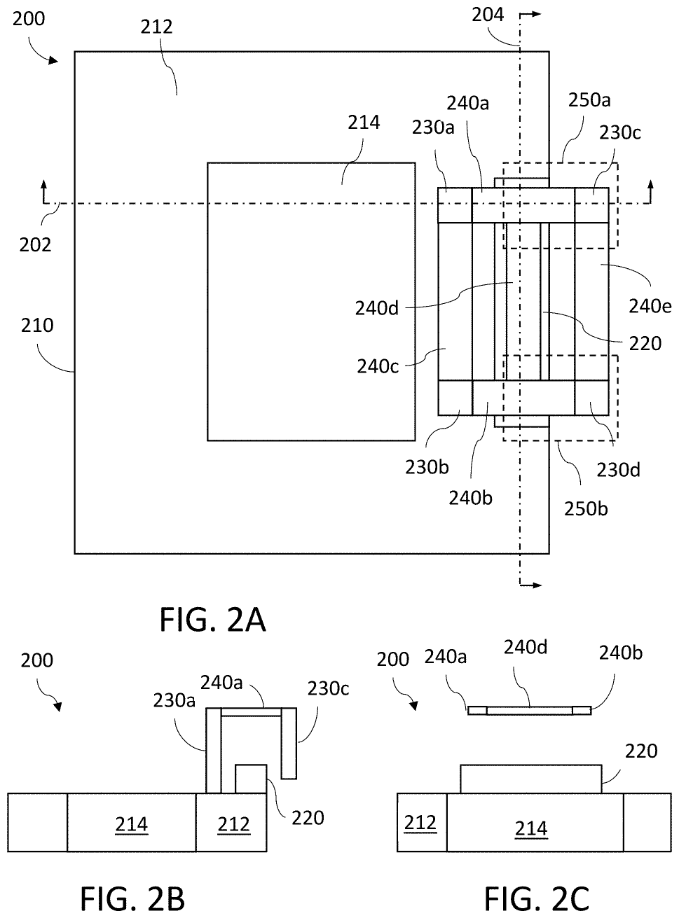

FIGS. 2A-2C show simplified schematics of another example portion of an aircraft 200, with a base plate 210 and exposed electronics assembly 220. In this example, the electronics assembly 220 is located within an outer perimeter region 212 of the base plate 210, and a bracket flange is used that extends beyond the peripheral edge of the base plate 210. FIG. 2A is a plan view schematic, with two cut plane lines 202 and 204. FIGS. 2B and 2C show side view schematics of cross-sectional views corresponding to cut plane lines 202 and 204, respectively.

In this example, the base plate 210 contains an outer perimeter region 212 and an inner region 214, where the electronics assembly 220 is mounted to the outer perimeter region 214 of the base plate 210. The upper surface of base plate 210 and the electronics assembly 220 are exposed to the environment and the electronics assembly 220 is protected by a lightweight enclosure with many openings through which air and gases flow. The enclosure is a bracket flange made from a conductive material (e.g., metal) in the example shown in FIGS. 2A-2C. The bracket flange contains two legs 230a and 230b coupled to the base plate 210, two legs 230c and 230d outside of the perimeter edge of the base plate 220, and five bars 240a-e extending substantially parallel to the base plate 210. In this example, legs 230a-d and bars 240a-e of the bracket flange form a cage over the electronics assembly 220.

Similar to the example shown in FIGS. 1A-1C, the electronics assembly 220 is electrically insulated from the bracket flange so that surge currents can be conducted away from electronics assembly 220 by the bracket flange without damaging electronics assembly 220. FIGS. 2A-2C show an example where the electronics assembly 220 is mounted to the base plate 210. In some cases, the electronics assembly 220 is mounted to the base plate using electrically insulating standoffs between the electronics assembly 220 and the base plate 210 to electrically insulate the electronics assembly 220 from the base plate 210. In other embodiments, the electronics assembly 220 can be mounted to a leg (e.g., 230a-d) or bar (e.g., 240a-e) of the bracket flange in such a way that the electronics assembly 220 is electrically insulated from the bracket flange (e.g., using electrically insulating standoffs or other electrically insulating spacers between the electronics assembly 220 and the bracket flange) and from the base plate 210 (by physically separating the electronics assembly 220 from the base plate 210).

FIG. 2B shows a simplified schematic of a cross-section of the example portion of the aircraft 200, taken through cut plane line 202. One end of the leg 230a is coupled to the outer perimeter region 212 of base plate 210, and the bar 240a extends from the other end of the leg 230a on a plane substantially parallel to the base plate 210 and over part of the electronics assembly 220. The bracket flange in this example extends beyond the peripheral edge of the base plate 220 where two additional legs 230c and 230d extend downward from bars 240a and 240b. In this example, legs 230c and 230d are perpendicular to the base plate but do not contact the base plate, and the bracket flange is supported by legs 230a and 230b.

The three additional bars 240c-e in the bracket flange in FIGS. 2A-2C extend from bar 240a to bar 240b in a plane substantial perpendicular to bar element 240a and parallel to the base plate 210. FIG. 2C shows a simplified schematic of a cross-section of the example portion of the aircraft 200, taken through cut plane line 204. FIG. 2C shows the configuration of bars 240a, 240b and 240d over part of the electronics assembly 120.

In the example shown in FIGS. 2A-2C, the legs 230a and 230b are coupled to the outer perimeter region 212 of the base plate 210. In some embodiments, the position of the legs 230a-d and the bars 240a-e are determined using a lightning attachment survey as described herein. In the example shown in FIG. 2A, regions 250a and 250b of the base plate 210 are prone to lightning attachment, as shown by lightning streamers from a lightning attachment survey (see, e.g., FIGS. 4A-4C). Legs 230c and 230d and bars 240a-b and 240d-e of the bracket flange are located within and/or covering regions 250a and 250b to prevent the lightning streamers from attaching to the electronics assembly 220. The position of legs 230a-d and bars 240a-e are further designed to direct potentials and currents away from the electronics assembly 220 thereby protecting the electronics assembly from electrical storm activity.

The dimensions of the bracket flanges in the examples shown in FIGS. 1A-1C and 2A-2C can be determined such that the bracket effectively diverts surge current from the electrical surge away from the covered electronics assemblies. For example, the height between the electronics assembly 120 and the bar 140a in FIG. 1B can be chosen to effectively protect the electronics assembly 120. Furthermore, the placement of bars 140a and 140b with respect to the electronics assembly 120 in FIG. 1A can be chosen to effectively protect the electronics assembly 120.

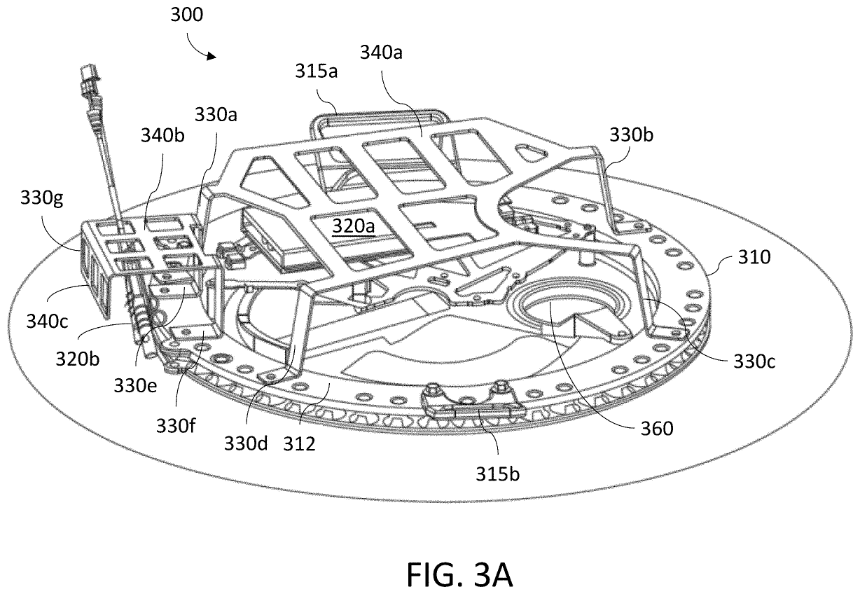

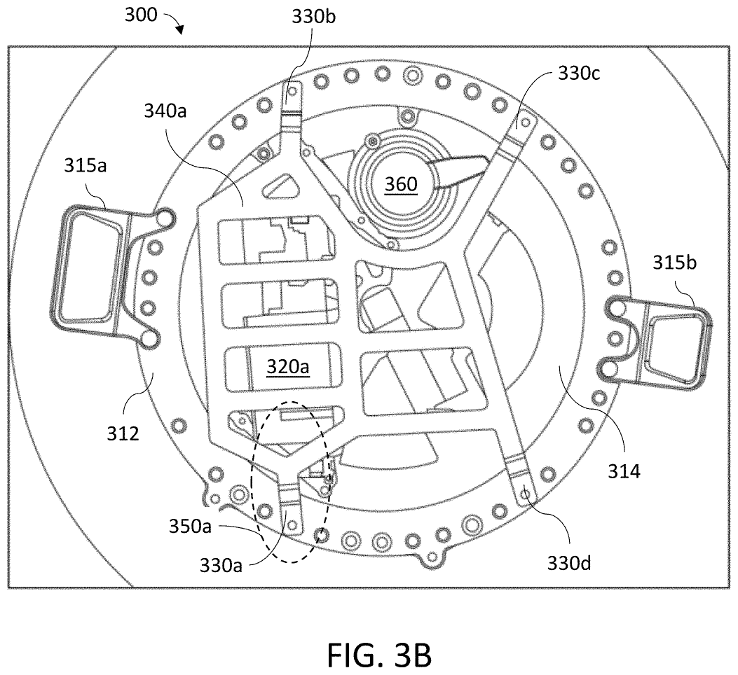

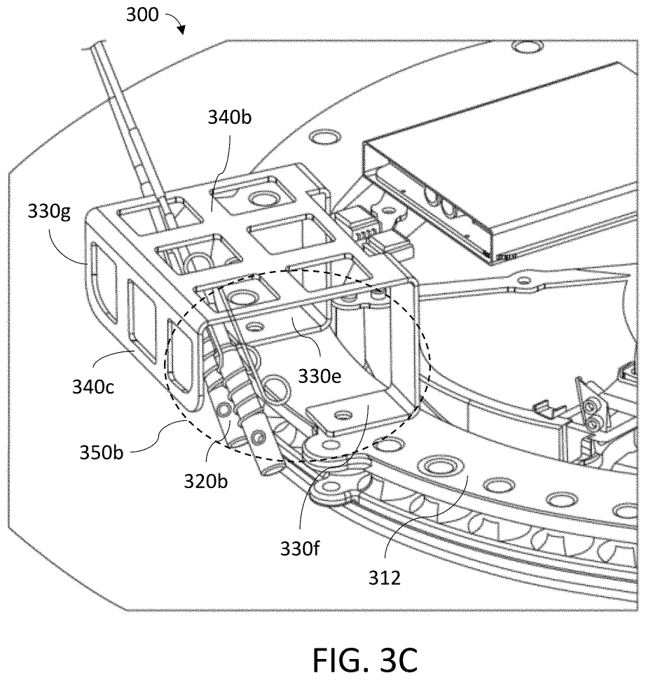

FIGS. 3A-3C show simplified schematics of an example portion of a balloon vehicle 300, with a base plate 310 and two exposed electronics assemblies 320a and 320b. FIG. 3A shows the base plate 310 and the two exposed electronics assemblies 320a and 320b covered by two bracket flanges in projection view. FIG. 3B shows a top down view of the base plate 310 and the first bracket flange. FIG. 3C shows a projection view of the base plate 310 and the second bracket flange.

In this example, the base plate 310 contains an outer perimeter region 312 and an inner region 314, where the electronics assembly 320a is mounted to the inner region 314 of the base plate 310 and the electronics assembly 320b is mounted to the outer perimeter region 312 of the base plate 310 such that the electronics assemblies 320a-b are electrically insulated from the base plate 310 (e.g., using insulating standoffs). In other embodiments, the electronics assemblies 320a-b can be mounted to the bracket flanges in such a way that electronics assemblies 320a-b are electrically insulated from the bracket flanges and the base plate 310 (e.g., using insulating standoffs and/or air gaps). The base plate 310 is mounted to an apex of the balloon vehicle in this example, and the upper surface of base plate 310 and the electronics assemblies 320a and 320b are exposed to the environment. Two handles 315a and 315b are also shown, which are used for installation of the base plate 310. The two electronics assemblies 320a and 320b are each protected by a lightweight bracket flange with many openings through which air and gases flow. The bracket flanges are made from a conductive material (e.g., thin strips of metal, or a piece of sheet metal with a plurality of holes) in the example shown in FIGS. 3A-3C. The first bracket flange contains four legs 330a-d, each leg coupled to the base plate 310, and a plurality of bars 340a extending substantially parallel to the base plate 310. The second bracket flange contains two legs 330e and 330f, each leg coupled to the base plate 310, a plurality of bars 340b extending substantially parallel to the base plate 310, and additional legs 330g and additional bars 340c extending beyond the peripheral edge of the base plate 310. In this example, the first and second bracket flanges form first and second cages over the first and the second electronics assemblies 320a and 320b, respectively.

FIGS. 3A-3B also include an inlet 360 for adding gas (e.g., helium) to fill an envelope of the balloon vehicle. The legs 330a-d and the bars 340a of the first flange in this example are located to allow access to the inlet 360, for example to couple a conduit to inlet 360.

In the example shown in FIGS. 3A-3C, the legs 330a-f are coupled to the outer perimeter region 312 of the base plate 310. In some embodiments, the position of the legs 330a-f and the bars 340a-c are determined using a lightning attachment survey as described herein.

In the example shown in FIG. 3B, region 350a of the base plate 310 is prone to lightning attachment, as indicated by lightning streamers from a lightning attachment survey (see, e.g., FIGS. 4A-4C). Leg 330a and a portion of bars 340a of the first bracket flange are located within and/or are partially or wholly cover region 350a to prevent the lightning streamers from attaching to the electronics assembly 320a. The position of legs 330a-d and bars 340a are further designed to direct potentials and currents away from the electronics assembly 320a thereby protecting the electronics assembly 320a from electrical storm activity.

In the example shown in FIG. 3C, region 350b of the base plate 310 is prone to lightning attachment, as indicated by lightning streamers from a lightning attachment survey (see, e.g., FIGS. 4A-4C). Legs 330e and 330f and a portion of bars 340b of the second bracket flange are located within and/or are covering region 350b to prevent the lightning streamers from attaching to electronics assembly 320b. The position of legs 330e-g and bars 340b and 340c are further designed to direct potentials and currents away from the electronics assembly 320b thereby protecting the electronics assembly 320b from electrical storm activity.

FIGS. 4A-4C show examples of lightning attachment surveys with different bracket flanges 430a and 430b designed to protect electronics assemblies (not shown) mounted on a base plate 410 of a balloon vehicle.

FIG. 4A shows a simplified schematic of the setup for a lightning attachment survey, in projection view. A base plate 410 (with electronics assemblies, bracket flanges, and other components of a balloon vehicle mounted thereon) is suspended from insulating ropes 440, and a cable 450 is used to apply a transient voltage (e.g., about 1 kV) from a generator (or power supply) 470 to the base plate 410. Lightning streamers 480 form when the transient voltage is applied, and the locations where lightning streamers attach to base plate 410, or components coupled thereon, can be used to design the bracket flanges to protect the electronics assemblies.

FIG. 4B shows the base plate 410 and a first bracket flange 430a covering electronics assemblies (not shown) on the base plate 410. The bracket flange has legs and bars positioned to protect electronics assemblies mounted to the base plate 410, and as a result, most of the lightning streamers in FIG. 4B are attached to robust (i.e., insensitive) areas of the base plate (e.g., in the case of lightning streamer 460a) or the handles (e.g., in the case of lightning streamers 460b-d). However, the lightning attachment survey in FIG. 4B shows that one lightning streamer 460e is attached to a sensitive electronics assembly (not shown) close to the perimeter edge of the base plate 410.

FIG. 4C shows the same base plate 410 and bracket flange 430a as in FIG. 4B, and also includes an additional bracket flange 430b to protect the sensitive electronics assembly (not shown) close to the perimeter edge of the base plate 410. FIG. 4C shows that two lightning streamers 460f and 460g are attached to the bracket flange 430b and the lightning streamer (460e in FIG. 4B) that was attached to the electronics assembly below bracket flange 430b is no longer present. This indicates that bracket flange 430b effectively protects the electronics assembly below.

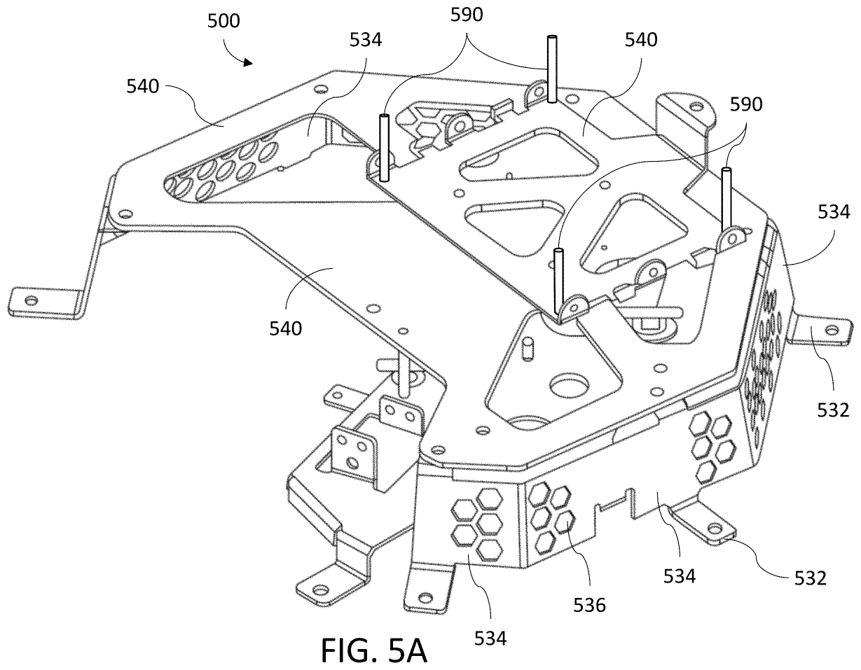

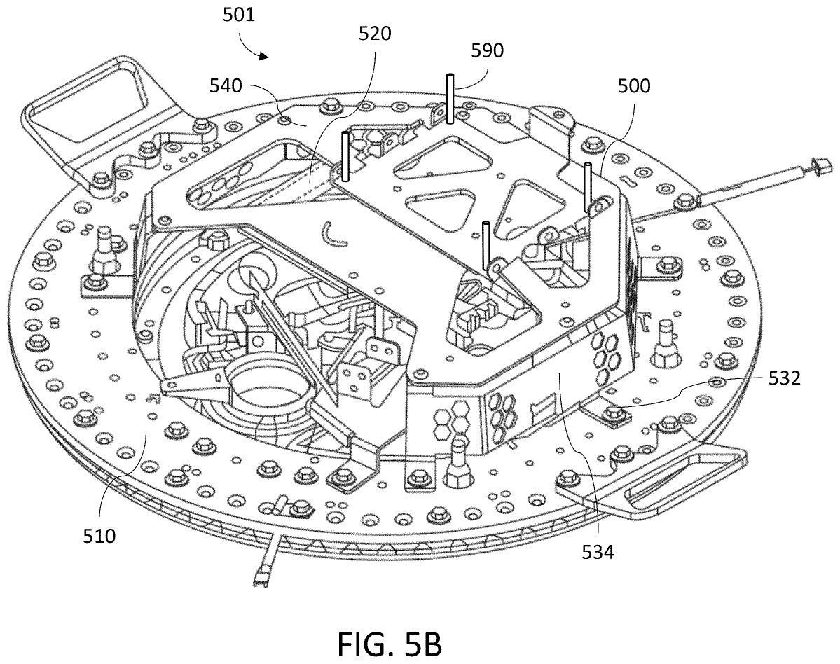

FIG. 5A shows a simplified schematic in projection view of an example bracket flange 500 for a balloon vehicle. FIG. 5B shows a simplified schematic in projection view of an example portion of a balloon vehicle 501, with bracket flange 500 coupled to a base plate 510 and extending over electronics assembly 520.

In this example, bracket flange 500 contains leg element 534, which is in a plane approximately perpendicular to the base plate 510, and a plurality of bar elements 540, which are in planes approximately parallel with the base plate 510. The leg element 534 may have multiple sections and or a plurality of leg elements 534 may be implemented, each of which may be coupled to one or more bar elements 540. The leg elements 534 and bar elements 540 can be formed from one piece of material (e.g., a thin piece of metal) or can be formed from multiple pieces of material that are coupled together (e.g., by welding, bolts or other couplings). The leg element 534 is coupled to the base plate 510 at leg coupling elements 532, for example, using bolts. The bar elements are coupled to the leg elements and extend over electronics assembly 520. The leg element 534 and the bar elements 540 in this example form a cage around the electronics assembly 520. The leg element 534 in this example is formed from a single piece and contains a plurality of holes 536. The holes can be beneficial, for example, to reduce the weight of the bracket flange 500 and to allow for gases to flow through the bracket flange 500.

In this example, the electronics assembly 520 is mounted to the base plate 510 such that the electronics assembly 520 is electrically insulated from the base plate 510 (e.g., using insulating standoffs) and from the bracket flange 500 (because the electronics assembly 520 and the bracket flange 500 are physically separated). In other examples, the electronics assembly 520 can be mounted to the bracket flange such that the electronics assembly 520 is electrically insulated from the bracket flange (e.g., using insulating standoffs) and from the base plate 510 (because the electronics assembly 520 and the base plate 510 are physically separated).

The bracket flange 500 in this example also includes four lightning rods 590 coupled to the bracket flange 500, extending out from the bracket flange 500 in substantially perpendicular planes to the base plate 510. The lightning rods can protect the electronics assembly 520 by attracting lightning streamers to the lightning rods and preventing them from attaching to the electronics assembly 520.

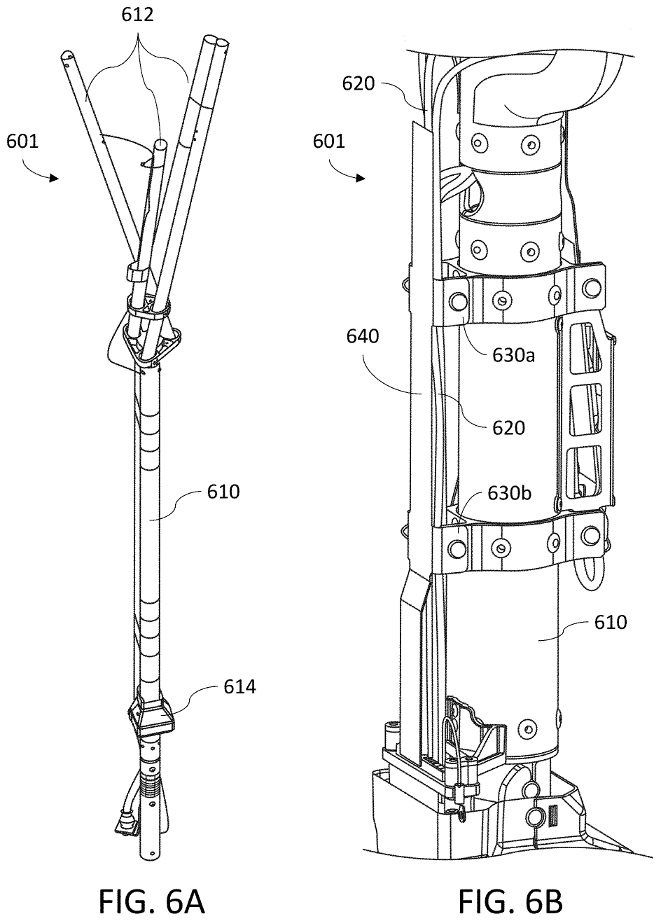

FIG. 6A shows a simplified schematic in projection view of an example portion 601 of a balloon vehicle with a down connect 610. FIG. 6B shows a bracket flange coupled to a part of the down connect 610 and extending over an electronics assembly 620. The bracket flange shown in FIG. 6B can be coupled to any part of the portion 601 shown in FIG. 6A to protect any exposed electronics assemblies. In FIG. 6A, portion 601 comprises a down connect 610, down connect legs 612, and a down connect coupler 614. FIG. 6B is a more detailed schematic showing a region of the portion 601 with additional components including electronics assembly 620 and the bracket flange. The bracket flange in this example contains leg elements 630a-b as well as two other leg elements (not shown) that are coupled to the down connect 610 (e.g., using bolts), and a bar element 640 that is coupled to leg elements 630a-b and extends over electronics assembly 620. The electronics assembly 620 in this example is a wire (i.e., any type of electrical connecting element, such as insulated electrical wires that transmit power or data) that electrically connects electronics of the envelope or hull of the balloon vehicle with electronics in the payload of the vehicle, and is coupled to the down connect 610. In other cases, the electronics assembly 620 can be coupled to the bracket flange such that the electronics assembly 620 is electrically insulated from the bracket flange. The down connect 610 can be made from a lightweight metal, such as aluminum, in some cases.

FIG. 6A shows down connect legs 612 at one end of the down connect 610 that couple to the envelope or hull of the balloon vehicle and a down connect coupler 614 at the other end of the down connect 610 that couples to the payload of the balloon vehicle. The example in FIG. 6A includes three down connect legs 612 in a tripod arrangement, but in other cases, there can be more or fewer than 3 down connect legs, such as from 1 to 10, or 1, or 2, or 4, or 6 down connect legs.

FIG. 6B shows the bracket flange (containing leg elements 630a-b (as well as two other leg elements (not shown) and bar element 640) coupled to the down connect 610 and covering the electronics assembly 620. The leg elements 630a-b and the bar element 640 in this example form a cage around the electronics assembly 620 and allows for air flow to reach electronics assembly 620. The leg elements and bar element in this example can be formed from a single piece (e.g., stainless steel) or formed from multiple pieces that are coupled (e.g., welded) together.

Example Methods

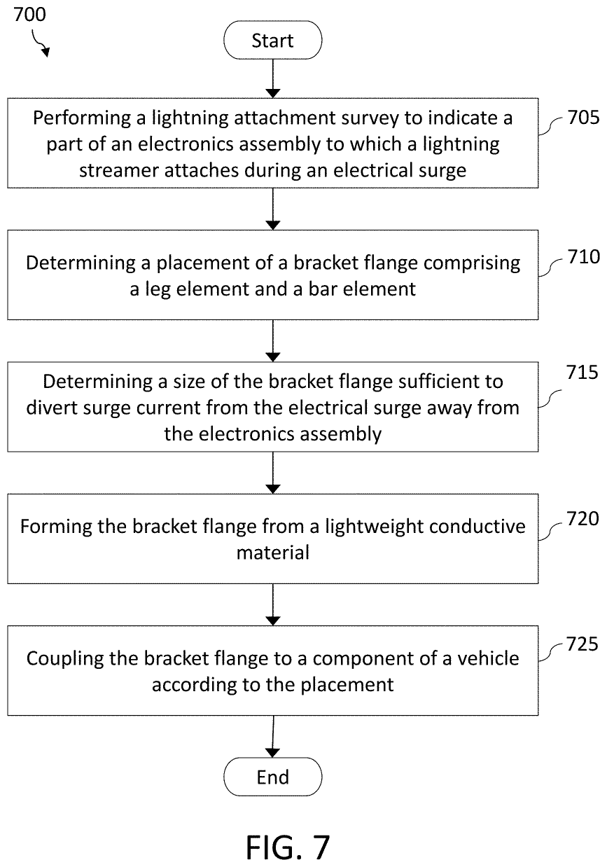

In some embodiments, a method 700 for providing a lightweight bracket flange to protect an electronics assembly from electrical storm activity is shown in FIG. 7. The electronics assembly is coupled to a component (e.g., a base plate or a down connect) of a vehicle (e.g., an aerial vehicle, or a balloon vehicle). The electronics assembly may be exposed, such that it is susceptible to damage due to lightning or other electrical storm activity. In step 705 of method 700 a lightning attachment survey is performed. In some cases, the lightning attachment survey is performed in compliance with an industry standard test methodology and procedure (e.g., Section 22 and/or Section 23 of RTCA DO-160). The lightning attachment survey is configured to indicate a part of an electronics assembly to which lightning and other surge currents are likely to attach during an electrical surge, where the electrical surge is configured to mimic electrical storm activity. In step 710, a placement of a bracket flange is determined. The bracket flange can have a leg element and a bar element, where the leg element is coupled to the component of the vehicle (e.g., to an outer perimeter of a base plate). In step 715, a size of the bracket flange is determined. In some cases, the size comprises a width and height sufficient to divert surge current from the electrical surge away from the electronics assembly. The size of the bracket can be determined using any method described herein, such as ensuring that there is a sufficient distance between the bracket and the electronics assembly (e.g., compared to the height of the electronics assembly or the height of a portion of the component of the vehicle), or ensuring that the electronics assembly is shaded by the bracket (e.g., using cones extending down from the bracket as described herein). In step 720, the bracket flange is formed from a lightweight conductive material, such as strips of metal coupled together, or a piece of sheet metal with a plurality of holes. In step 725, the bracket flange is coupled to the component of the vehicle according to the placement. The bracket flange may be coupled to any component of the vehicle, such as a base plate or a down connect coupling an envelope or hull to a payload of the vehicle. In some embodiments, method 700 further comprises coupling the base plate to an exterior surface of the aerial vehicle.

In some embodiments of method 700, the leg element comprises two or more legs, where each of the two or more legs are coupled to a different location on the outer perimeter of the component (e.g., a base plate or down connect). In some embodiments of method 700, the leg element and the first bar element form a cage over the electronics assembly. In some embodiments of method 700, the bracket flange further comprises a second bar element extending from an end or an edge of the first bar element in a plane substantially perpendicular to the first bar element.

In some embodiments of method 700, the vehicle is an aerial vehicle and a squib configured to terminate the flight of an aerial vehicle is coupled to a base plate of the aerial vehicle and the placement is configured to place the leg element and the first bar element in a configuration configured to divert surge current away from the squib and prevent the squib from firing prematurely. In some embodiments of method 700, the base plate further comprises an inlet port for filling a lighter than air envelope with a gas, and the bracket flange is configured to provide a space without bars blocking the inlet port.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements.

What is claimed is:

1. A bracket flange for protecting an electronics assembly from electrical storm activity, the bracket flange comprising:
a leg element coupled to and extending from a base plate at one end of the leg element, an electronics assembly being mounted, at least in part, to the base plate; and
a first bar element extending from another end of the leg element on a plane substantially parallel to the base plate and over a part of the electronics assembly,
wherein the leg element is coupled to a location on an outer perimeter of the base plate, the location being determined using a lightning attachment survey configured to indicate a part of the electronics assembly to which a lightning streamer attaches during an electrical surge, the electrical surge configured to mimic the electrical storm activity;
wherein the location is configured to place the leg element and first bar element in a configuration configured to divert surge current away from the part of the electronics assembly to which the lightning streamer attaches in the lightning attachment survey, and
wherein the leg element and first bar element are formed of a conductive material.

2. The bracket flange of claim 1, wherein the leg element comprises two or more legs, each of the two or more legs coupled to a different location on the outer perimeter of the base plate.

3. The bracket flange of claim 1, wherein the leg element and the first bar element form a cage over the electronics assembly.

4. The bracket flange of claim 1, further comprising a second bar element extending from an end or an edge of the first bar element in a plane substantially perpendicular to the first bar element.

5. The bracket flange of claim 1, wherein the leg element and first bar element comprise strips of metal.

6. The bracket flange of claim 1, wherein the electronics assembly comprises a component of an aerial vehicle.

7. The bracket flange of claim 6, wherein a squib configured to terminate the flight of the aerial vehicle is coupled to the base plate and the location is configured to place the leg element and the first bar element in a configuration configured to divert surge current away from the squib and prevent the squib from firing prematurely.

8. The bracket flange of claim 6, wherein the base plate further comprises an inlet port for filling a lighter than air envelope with a gas, and the bracket flange is configured to provide a space without legs or bars blocking the inlet port.

9. The bracket flange of claim 1, wherein the bracket flange further comprises a lightning rod.

10. A method for providing a bracket flange to protect an electronics assembly on a vehicle from electrical storm activity, comprising:
performing a lightning attachment survey configured to indicate a part of an electronics assembly to which a lightning streamer attaches during an electrical surge, the electrical surge configured to mimic the electrical storm activity;
determining, based on the lightning attachment survey, a placement of a bracket flange comprising a leg element and a first bar element;
determining a size of the bracket flange;
forming the bracket flange from a lightweight conductive material; and
coupling the bracket flange to a component of a vehicle according to the placement, wherein the electronics assembly is electrically insulated from the bracket flange.

11. The method of claim 10, wherein the placement of a bracket flange is based on the location of the electronics assembly to which the lightning streamer attaches during the lightning attachment survey.

12. The method of claim 10, wherein the leg element comprises two or more legs, each of the two or more legs coupled to a different location on the component of the vehicle.

13. The method of claim 10, wherein the leg element and the first bar element form a cage over the electronics assembly.

14. The method of claim 10, wherein the bracket flange further comprises a second bar element extending from an end or an edge of the first bar element in a plane substantially perpendicular to the first bar element.

15. The method of claim 10, wherein the leg element and first bar element comprise strips of metal with thicknesses from 1 mm to 5 mm.

16. The method of claim 10, wherein the component of the vehicle and the electronics assembly are components of an aerial vehicle.

17. The method of claim 16, wherein a squib configured to terminate the flight of the aerial vehicle is coupled to the component of the vehicle and the placement is configured to place the leg element and the first bar element in a configuration configured to divert surge current away from the squib and prevent the squib from firing prematurely.

18. The method of claim 16, wherein the component of the vehicle further comprises an inlet port for filling a lighter than air envelope with a gas, and the bracket flange is configured to provide a space without bars blocking the inlet port.

19. The method of claim 10, wherein the component of the vehicle is a base plate of an aerial vehicle.

20. The method of claim 19, wherein the leg element is coupled to an outer perimeter of the base plate and the electronics assembly is coupled to the base plate.

21. The method of claim 10, wherein the component of the vehicle is a down connect coupling an envelope or a hull to a payload of the vehicle, the electronics assembly comprises wiring, and the wiring is coupled to the down connect.

22. The method of claim 10, wherein the size of the bracket flange comprises a width and a height sufficient to divert surge current from the electrical surge away from the electronics assembly.

23. The method of claim 10, wherein the bracket flange further comprises a lightning rod.
